(19) United States
(12) Patent Application Publication
(10) Pub. No.: US 2026/0203201 A1
(43) Pub. Date: Jul. 16, 2026

(54) AUTOMATED TEST CASE SELECTION USING ANOMALY DETECTION

(71) Applicant: Telefonaktiebolaget LM Ericsson (publ), Stockholm (SE)

(72) Inventors: Giriprasad SRIDHARA, Bangalore (IN); Ravi Teja GANDHAM, Bangalore (IN); Sourav MAZUMDAR, Bangalore (IN)

(73) Assignee: Telefonaktiebolaget LM Ericsson (publ), Stockholm (SE)

(21) Appl. No.: 19/138,163

(22) PCT Filed: Dec. 15, 2022
(86) PCT No.: PCT/IN2022/051076

§ 371 Date: Jun. 12, 2025

(51) Int. Cl. G06F 11/3668; G06N 20/10

(52) U.S. Cl. CPC G06F 11/3692; G06F 11/3688; G06N 20/10

(57) ABSTRACT

A method for selecting at least one test case for testing a software module or a hardware module is provided. The method comprises obtaining test data indicating a plurality of test cases, and using a machine learning (ML) model, performing an anomaly detection on the plurality of test cases. The method further comprises, as a result of performing the anomaly detection on the plurality of test cases, selecting from the plurality of test cases one or more test cases for testing a software module or a hardware module.

### TECHNICAL FIELD

This disclosure relates to automated test case selection using anomaly detection.

### BACKGROUND

Software Quality Assurance (QA) is very important, especially, for commercial software. QA can be provided in different complementary ways. Examples of ways of providing QA include: (1) software testing which executes test cases against actual product to detect problems; (2) static analysis of source code to detect potential problems such as potential null pointer exceptions (e.g., using Lint/Sonarqube); and (3) manual code review by experienced developers.

Modern software applications typically have millions of lines of code. To improve the quality of software system and to detect any fault in individual software modules, it is desirable to test the software system using test cases. These test cases can range from hundreds to even thousands of test cases that span across multiple test suites.

In upgrading a software system, new features (e.g., new functionalities) may be added to the software system. In such scenario, all test cases must be rerun so that no existing functionality is broken during the upgrade. However, it is time consuming and infeasible to run such large numbers of test cases every time the software system is upgraded (e.g., the code is modified). More specifically, since each test case will require a finite amount of time to execute, it will take a long time to execute all test cases, which may not be possible in practice due to resource constraints. One way to solve this problem is selecting a subset of the overall test cases and then only rerunning the selected subset of the test cases, in order to ensure that existing functionality of the software system (e.g., the code) still works well even after the upgrade or modification.

### SUMMARY

Certain challenges presently exist. For example, the subset of test cases to be used for testing the software system is usually selected manually by subject matter experts (SME), and thus such test case selection method is error-prone, tedious, and time consuming as the SME must read each test case to evaluate the importance of the test case and decide whether to add the test case to the subset. Also, if fewer than optimal number of test cases are selected for the testing, the testing may result in failing to detect bugs. Conversely, selecting more than optimal number of test cases may result in longer test execution times, which may not be allowed or desirable in some modern Continuous Integration (CI)/Continuous Delivery (CD) pipeline (which focuses on rapid development and delivery).

To solve the problem of the manual test case selection, there are several automated techniques to select test cases. Typically, these techniques use a machine learning (ML) algorithm to determine which test cases must be selected for testing (e.g., by using a binary classification). In order to correctly learn the boundary between successful and failing test cases, these techniques require humongous amount of past execution data with an adequate ratio of successful test cases and failing test cases. However, there may be a scenario where there is not enough test case and/or more importantly, there may not be enough failing test cases (as can be expected from a well-developed commercial software). This may lead to the well-known class imbalance problem, which hinders a successful training of ML algorithms. Thus, existing techniques for automatically selecting test cases cannot be used.

Accordingly, in one aspect of the embodiments of this disclosure, there is provided a method for selecting at least one test case for testing a software module or a hardware module. The method comprises obtaining test data indicating a plurality of test cases; using a machine learning, ML, model, performing an anomaly detection on the plurality of test cases; and as a result of performing the anomaly detection on the plurality of test cases, selecting from the plurality of test cases one or more test cases for testing the software module or the hardware module.

In another aspect of the embodiments of this disclosure, there is provided a computer program comprising instructions which when executed by processing circuitry cause the processing circuitry to perform the method of at least one of the embodiments of this disclosure.

In another aspect of the embodiments of this disclosure, there is provided a carrier containing the computer program of the embodiments above, wherein the carrier is one of an electronic signal, an optical signal, a radio signal, and a computer readable storage medium.

In another aspect of the embodiments of this disclosure, there is provided an apparatus for selecting at least one test case for testing a software module or a hardware module. The apparatus is configured to obtain test data indicating a plurality of test cases; using a machine learning, ML, model, perform an anomaly detection on the plurality of test cases; and as a result of performing the anomaly detection on the plurality of test cases, select from the plurality of test cases one or more test cases for testing the software module or the hardware module.

In another aspect of the embodiments of this disclosure, there is provided an apparatus. The apparatus comprises a processing circuitry; and a memory, said memory containing instructions executable by said processing circuitry, whereby the apparatus is operative to perform the method of at least one of the embodiments described above.

As briefly explained above, an ML model can be used to select from a plurality of test cases some test cases for testing software code (herein after, “code”). One way of training the ML model is using a supervisory learning that is based on a binary classification. More specifically, the ML model can be trained to output a first value if a successful test case is inputted to the ML model while the ML model can be trained to output a second value if a failed test case is inputted to the ML model.

However, training the ML model based on a binary classification requires a balanced ratio of successful test cases and failed test cases. For example, if not enough successful or failed test cases are used for training the ML model, the ML model may not be trained properly, thereby failing to classify input test cases properly. But there are not many failed test cases for a well-developed commercial software. This imbalanced ratio of the successful test cases and the failed test cases renders the binary classification inappropriate for training the ML model. Some embodiments of this disclosure solve this problem by training the ML model based on anomaly detection-treating each failed test cases as an anomaly. Unlike the binary classification, training the ML model based on anomaly detection does not require a balanced ratio of successful test cases and failed test cases, and thus the ML model trained based on the anomaly detection can identify the failed test cases (i.e., the anomalies) successfully.

### BRIEF DESCRIPTION OF THE DRAWINGS

The accompanying drawings, which are incorporated herein and form part of the specification, illustrate various embodiments.

FIG. 1 shows a process of upgrading a module according to some embodiments.

FIGS. 2A and 2B show operations of a machine learning (ML) model according to some embodiments.

FIG. 3A shows a structure of a TabNet encoder.

FIG. 3B shows a structure of a TabNet decoder.

FIG. 4A shows a structure of a feature transformer.

FIG. 4B shows a structure of an attentive transformer.

FIG. 5 shows an overview of a process for selecting test cases for testing a module, according to some embodiments.

FIG. 6 shows a process according to some embodiments.

FIG. 7 shows an apparatus according to some embodiments.

### DETAILED DESCRIPTION

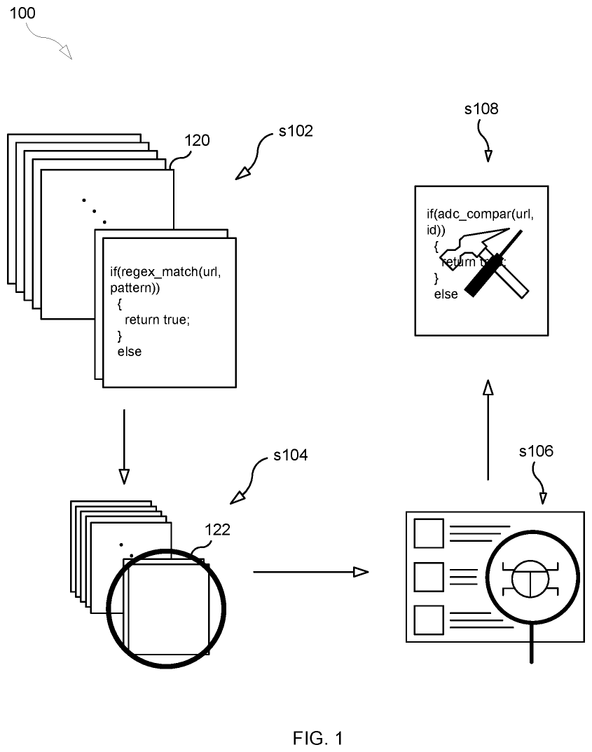

FIG. 1 shows a process 100 for upgrading a module according to some embodiments. The module may be a software module or a hardware module. For simple explanation purpose, process 100 is explained below using a software module.

Process 100 may begin with step s102. Step s102 comprises obtaining test data indicating a plurality of test cases 120. In case the testing subject is a software module (a.k.a., “software application” or “software”), each of the plurality of test cases 120 may correspond to lines of programing codes that can be run at the software module for testing the software module.

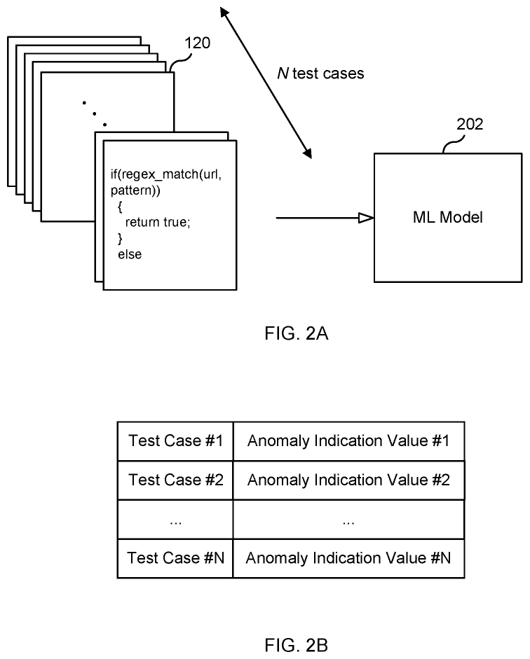

As briefly explained above, it is not desirable to use all of the available test cases 120 for testing the software module because of resource constraint. For example, due to time constraint, in some cases, there may not be enough time to test the software module using all of the available test cases 120. Thus, according to some embodiments, in step s104, a group of one or more test cases 122 is selected from the plurality of test cases 120. The method of selecting test cases 122 for testing the software module is explained in detail with respect to FIG. 2 below.

After selecting test cases 122, process 100 may proceed to step s106. Step s106 comprises running the selected test cases 122 at the software module to find software bugs in the software module. After finding the software bugs, process 100 may proceed to step s108 which comprises fixing the software bugs of the software module, thereby improving the performance of the software module.

Referring back to step s104, in selecting test cases 122 for testing the software module, an ML model may be used. In this disclosure, an ML model includes a deep learning (DL) model.

As discussed above, test cases available for testing a well-developed commercial software may be imbalanced. More specifically, a number of successful test cases (e.g., the testing software codes resulting in successful results when run by software) may be much more than a number of failed test cases (e.g., the testing software codes resulting in failure results when run by software module). Because of this imbalance in the available number of test cases in the two categories (i.e., the successful test cases and the failed test cases), using a binary classification ML model to select the test cases 122 is not desired. Note that, in this disclosure, an imbalanced ratio of successful test cases to failed test cases means that a ratio of the successful test cases to the failed test cases is greater than or equal to 7:3 (e.g., 8:2, 9:1, etc.).

Therefore, according to some embodiments, an ML model for an anomaly detection is used to select test cases 122 from test cases 120. More specifically, as shown in FIG. 2A, test data indicating the test cases 120 may be provided to ML model 202. ML model 202 may be configured to perform an anomaly detection on test cases 120, thereby generating, for each test case, an anomaly indication value indicating a degree and/or a probability of anomaly of the test case.

FIG. 2B shows N number of test cases and N number of anomaly indication values corresponding to the N number of test cases. Here N may correspond to the number of test cases 120.

Once the anomaly indication values corresponding to test cases 120 are obtained, in some embodiments, each of the anomaly indication values may be compared to a threshold value, and a test case is selected for testing based on the comparison. For example, in case anomaly indication value #1 is less than the threshold value but anomaly indication values #2 is greater than or equal to the threshold value, test case #1 is be selected for testing the software module, but test case #2 is selected for testing the software module.

Different kinds of an ML model may be used to implement ML model 202. In one example, an autoencoder may be used to implement ML model 202. Autoencoder is a neural network (NN) for encoding input data by compressing it into lower dimension(s), and then decoding the encoded input data, thereby reconstructing the original input data. The difference between the original input data and the reconstructed input data corresponds to a reconstruction error. These reconstruction errors may be used to detect anomalies. For example, normal input data may be detected in case the reconstruction error is small while anomaly input data may be detected in case the reconstruction error is large.

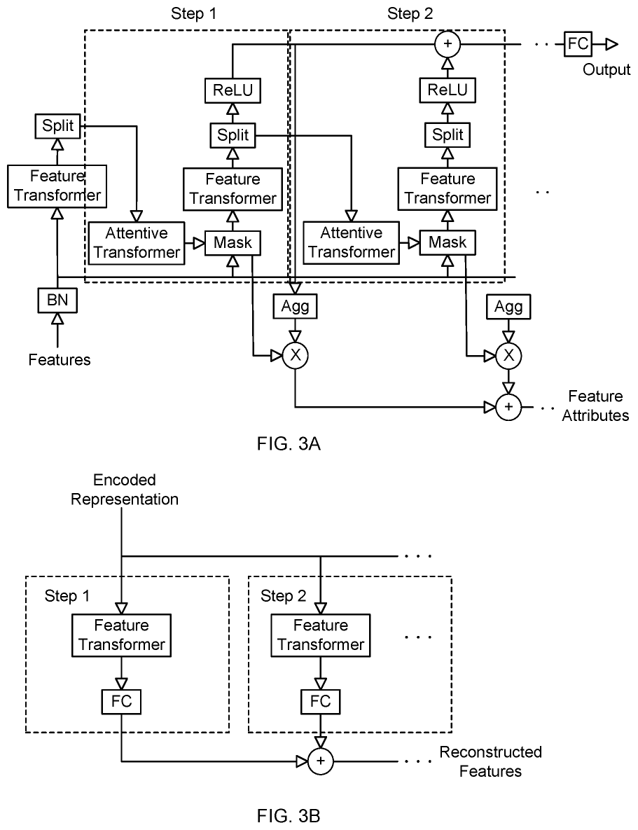

One specific example of the autoencoder for detecting anomalies is a Tabnet autoencoder. TabNet autoencoder is a deep tabular data learning architecture that uses sequential attention to choose which features to reason from at each decision step, enabling interpretability and more efficient learning as the learning capacity is used for the most salient features. A TabNet autoencoder comprises a TabNet encoder (shown in FIG. 3A) and a TabNet decoder (shown in FIG. 3B).

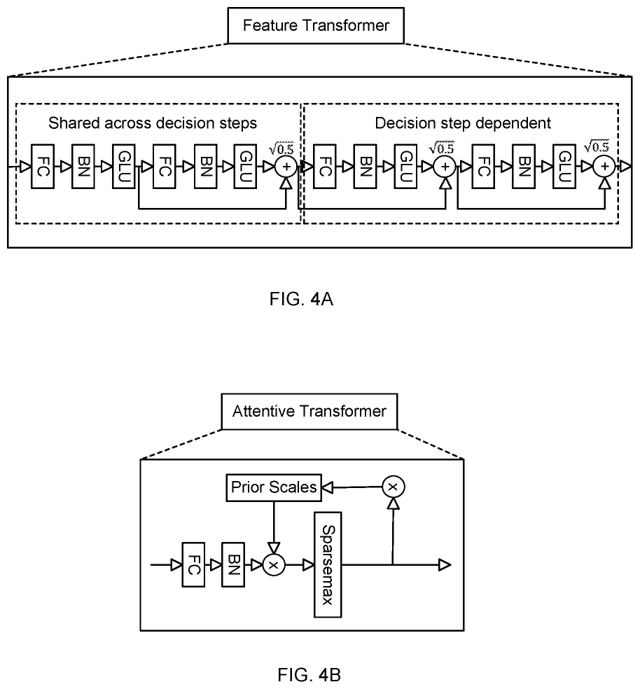

As shown in FIG. 3A, the TabNet encoder comprises an attentive transformer (shown in FIG. 4B), a feature transformer (shown in FIG. 4A), and a feature masking module. The attention transformer is configured to select the most important features for processing in the next step, and the feature transformer is configured to process features into more useful representations. As shown in FIG. 3B, the TabNet decoder comprises a feature transformer and a fully connected (FC) layer.

The TabNet autoencoder may be used to find anomalies in data. According to some embodiments, this function of the TabNet autoencoder is used for finding anomalies among test cases, and the anomaly test cases that are found can be used for testing the software module.

Tables 1 and 2 provided below show the evaluation result of identifying anomalies using the TabNet autoencoder under two different anomaly conditions-“relaxed” and “strict” conditions.

TABLE 1
Under relaxed “anomaly” condition

| | Precision | Recall | F1-Score | Support |
|---|---|---|---|---|
| 0 | 1.00 | 0.99 | 1.00 | 132 |
| 1 | 0.92 | 1.00 | 0.96 | 11 |
| Accuracy | | | 0.99 | 143 |
| Macro avg | 0.96 | 1.00 | 0.98 | 143 |
| Weighted avg | 0.99 | 0.99 | 0.99 | 143 |

TABLE 2
Under “Strict” Anomaly Condition

| | Precision | Recall | F1-Score | Support |
|---|---|---|---|---|
| 0 | 0.98 | 0.99 | 0.99 | 132 |
| 1 | 0.90 | 0.82 | 0.86 | 11 |
| Accuracy | | | 0.98 | 143 |
| Macro avg | 0.94 | 0.91 | 0.92 | 143 |
| Weighted avg | 0.98 | 0.98 | 0.98 | 143 |

As shown in the Tables 1 and 2 provided above, high recalls were obtained in both scenarios, which indicates that the TabNet autoencoder was able to capture most of the anomalies (i.e., being able to identify a vast majority of the failing test cases accurately and select them for execution). High recall of failing test cases is a strongly desired feature of any test case selection mechanism as it ensures that test cases that exercise faults are selected and thus faults do not escape into the field.

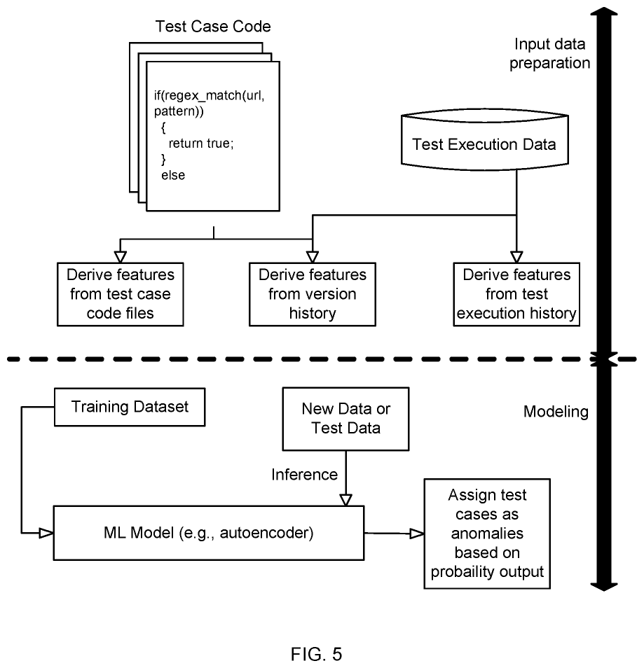

FIG. 5 shows an overview of a process for selecting test cases for testing the software module, according to some embodiments. The process comprises an input data preparation stage and a modeling stage. As shown in FIG. 5, during the input data preparation stage, test cases codes and text execution data corresponding to the test cases codes are obtained, and various features are derived from the test case codes and the test execution data. More specifically, as shown in FIG. 5, features may be derived from test case code files, version histories, test execution history, and these derived features may be used for forming training dataset.

The formed training dataset is provided to ML model 202, thereby training ML model 202 (i.e., determining weights of the ML model). Once ML model 202 is trained, during an inference stage, a new set of test cases is provided to the trained ML model 202. The trained ML model 202 is configured to generate probability values (a.k.a., “anomaly indication values”) each indicating a probability that each test may correspond to an anomaly. Based on analyzing these probability values, it may be determined whether to assign each test case as an anomaly or not, and based on these determination, a set of test cases to be used for testing can be selected.

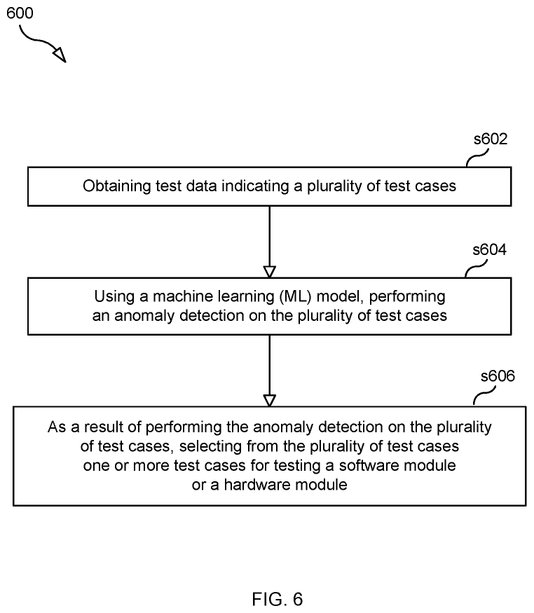

FIG. 6 shows a process 600 for selecting at least one test case for testing a software module or a hardware module, according to some embodiments. Process 600 may begin with step s602. Step s602 comprises obtaining test data indicating a plurality of test cases. Step s604 comprises, using a machine learning, ML, model, performing an anomaly detection on the plurality of test cases. Step s606 comprises, as a result of performing the anomaly detection on the plurality of test cases, selecting from the plurality of test cases one or more test cases for testing the software module or the hardware module.

In some embodiments, the plurality of test cases is associated with a particular computer program code; a test case included in the plurality of test cases is associated with a set of features, and the set of features comprises any one or more: a number of developers involved in developing the particular program code; a number of versions of the particular program code; a number of faults in the particular program code; a number of runs for executing the particular program code; a number of lines of the particular computer code; an age of the particular program code; a fault rate of the particular program code; and a mean execution time of the particular program code.

In some embodiments, performing the anomaly detection on the plurality of test cases comprises: using the ML model, generating a plurality of anomaly indication values each of which is associated with a test case included in the plurality of test cases, comparing each of the plurality of anomaly indication values to one or more threshold values, and based on a result of the comparisons, identifying said one or more test cases.

In some embodiments, each of the anomaly indication values associated with said one or more test cases is greater than said one or more threshold values.

In some embodiments, the plurality of test cases comprises a first group of test cases corresponding to a non-faulty operation and a second group of test cases corresponding to a faulty operation, and a ratio of a number of test cases in the first group of test cases to a number of test cases in the second group of test cases is an imbalanced ratio.

In some embodiments, the ML model is configured to receive input data, and process the received input data, thereby reconstructing the received input data.

In some embodiments, the plurality of test cases includes a first test case corresponding to a faulty operation and a second test case corresponding to a non-faulty operation, the ML model is configured to reconstruct the first test case and the second test case, thereby generating reconstructed test data indicating a reconstructed first test case and a reconstructed second test case, a reconstruction error between the first test case and the reconstructed first test case is greater than an error threshold value, and a reconstruction error between the second test case an d the reconstructed second test case is less than or equal to the error threshold value.

In some embodiments, the ML model is an autoencoder or an one class support vector machine.

In some embodiments, the test data is in the form of tabular data.

In some embodiments, the ML model is the autoencoder, the autoencoder comprises an encoder, the encoder comprises a plurality of encoder step modules, and an encoder step module comprises an attentive transformer, a feature transformer, a masking module, and a rectified linear unit, ReLU, activation function.

In some embodiments, the autoencoder comprises a decoder, the decoder comprises a plurality of decoder step modules, a decoder step module comprises a feature transformer and one or more fully connected layers.

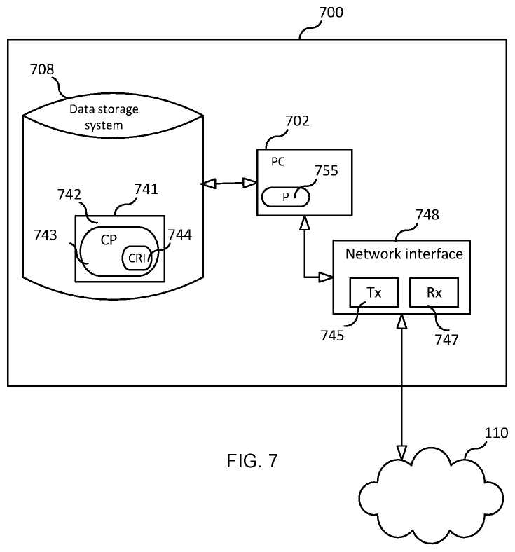

FIG. 7 is a block diagram of an apparatus 700, according to some embodiments, for performing any one or more of the steps shown in FIG. 1. As shown in FIG. 7, apparatus 700 may comprise: processing circuitry (PC) 702, which may include one or more processors (P) 755 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 700 may be a distributed computing apparatus); a network interface 748 comprising a transmitter (Tx) 745 and a receiver (Rx) 747 for enabling apparatus 700 to transmit data to and receive data from other nodes connected to a network 110 (e.g., an Internet Protocol (IP) network) to which network interface 748 is connected (directly or indirectly) (e.g., network interface 748 may be wirelessly connected to the network 110, in which case network interface 748 is connected to an antenna arrangement); and a local storage unit (a.k.a., “data storage system”) 708, which may include one or more non-volatile storage devices and/or one or more volatile storage devices. In embodiments where PC 702 includes a programmable processor, a computer program product (CPP) 741 may be provided. CPP 741 includes a computer readable medium (CRM) 742 storing a computer program (CP) 743 comprising computer readable instructions (CRI) 744. CRM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes apparatus 700 to perform steps described herein (e.g., steps described herein with reference to the flow charts). In other embodiments, apparatus 700 may be configured to perform steps described herein without the need for code. That is, for example, PC 702 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for selecting at least one test case for testing a software module or a hardware module, the method comprising:
obtaining test data indicating a plurality of test cases;
using a machine learning (ML) model, performing an anomaly detection on the plurality of test cases; and
as a result of performing the anomaly detection on the plurality of test cases, selecting from the plurality of test cases one or more test cases for testing the software module or the hardware module.

2. The method of claim 1, wherein
the plurality of test cases is associated with a particular computer program code,
a test case included in the plurality of test cases is associated with a set of features, and
the set of features comprises:
a number of developers involved in developing the particular program code;
a number of versions of the particular program code;
a number of faults in the particular program code;
a number of runs for executing the particular program code;
a number of lines of the particular computer code;
an age of the particular program code;
a fault rate of the particular program code; and/or
a mean execution time of the particular program code.

3. The method of claim 1, wherein performing the anomaly detection on the plurality of test cases comprises:
using the ML model, generating a plurality of anomaly indication values each of which is associated with a test case included in the plurality of test cases,
comparing each of the plurality of anomaly indication values to one or more threshold values, and
based on a result of the comparisons, identifying the one or more test cases.

4. The method of claim 3, wherein each of the anomaly indication values associated with the one or more test cases is greater than the one or more threshold values.

5. The method of claim 1, wherein
the plurality of test cases comprises a first group of test cases corresponding to a non-faulty operation and a second group of test cases corresponding to a faulty operation, and
a ratio of a number of test cases in the first group of test cases to a number of test cases in the second group of test cases is an imbalanced ratio.

6. The method of claim 1, wherein the ML model is configured to receive input data, and process the received input data, thereby reconstructing the received input data.

7. The method of claim 6, wherein
the plurality of test cases includes a first test case corresponding to a faulty operation and a second test case corresponding to a non-faulty operation,
the ML model is configured to reconstruct the first test case and the second test case, thereby generating reconstructed test data indicating a reconstructed first test case and a reconstructed second test case,
a reconstruction error between the first test case and the reconstructed first test case is greater than an error threshold value, and
a reconstruction error between the second test case and the reconstructed second test case is less than or equal to the error threshold value.

8. The method of claim 1, wherein the ML model is an autoencoder or a one class support vector machine.

9. The method of claim 1, wherein the test data is in the form of tabular data.

10. The method of claim 8, wherein
the ML model is the autoencoder,
the autoencoder comprises an encoder,
the encoder comprises a plurality of encoder step modules, and
an encoder step module comprises an attentive transformer, a feature transformer, a masking module, and a rectified linear unit (ReLU) activation function.

11. The method of claim 1, wherein
the autoencoder comprises a decoder,
the decoder comprises a plurality of decoder step modules, and
a decoder step module comprises a feature transformer and one or more fully connected layers.

12. A non-transitory computer readable storage medium storing a computer program comprising instructions which when executed by processing circuitry of an apparatus causes the apparatus to perform the method of claim 1.

13. (canceled)

14. An apparatus for selecting at least one test case for testing a software module or a hardware module, the apparatus comprising:
memory; and
Processing circuitry, wherein the apparatus is configured to:
obtain test data indicating a plurality of test cases;
using a machine learning (ML) model, perform an anomaly detection on the plurality of test cases; and
as a result of performing the anomaly detection on the plurality of test cases, select from the plurality of test cases one or more test cases for testing the software module or the hardware module.

15. The apparatus of claim 14, wherein
the plurality of test cases is associated with a particular computer program code,
a test case included in the plurality of test cases is associated with a set of features, and
the set of features comprises:
a number of developers involved in developing the particular program code;
a number of versions of the particular program code;
a number of faults in the particular program code;
a number of runs for executing the particular program code;
a number of lines of the particular computer code;
an age of the particular program code;
a fault rate of the particular program code; and/or
a mean execution time of the particular program code.

16. (canceled)

17. The apparatus of claim 14, wherein performing the anomaly detection on the plurality of test cases comprises:
using the ML model, generating a plurality of anomaly indication values each of which is associated with a test case included in the plurality of test cases,
comparing each of the plurality of anomaly indication values to one or more threshold values, and
based on a result of the comparisons, identifying the one or more test cases.

18. The apparatus of claim 17, wherein each of the anomaly indication values associated with the one or more test cases is greater than the one or more threshold values.

19. The apparatus of claim 14, wherein
the plurality of test cases comprises a first group of test cases corresponding to a non-faulty operation and a second group of test cases corresponding to a faulty operation, and
a ratio of a number of test cases in the first group of test cases to a number of test cases in the second group of test cases is an imbalanced ratio.

20. The apparatus of claim 14, wherein the ML model is configured to receive input data, and process the received input data, thereby reconstructing the received input data.

21. The apparatus of claim 20, wherein
the plurality of test cases includes a first test case corresponding to a faulty operation and a second test case corresponding to a non-faulty operation,
the ML model is configured to reconstruct the first test case and the second test case, thereby generating reconstructed test data indicating a reconstructed first test case and a reconstructed second test case,
a reconstruction error between the first test case and the reconstructed first test case is greater than an error threshold value, and
a reconstruction error between the second test case and the reconstructed second test case is less than or equal to the error threshold value.

22. The apparatus of claim 14, wherein the ML model is an autoencoder or a one class support vector machine.
